(19) United States
(12) Patent Application Publication
(10) Pub. No.: US 2006/0077016 A1
(43) Pub. Date: Apr. 13, 2006

(54) Lumped element non-reciprocal circuit device

(76) Inventors: Yuta Sugiyama, Tokyo (JP); Hideto Mikami, Kumagaya (JP); Hirohisa Sano, Fukaya (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/216,055

(22) Filed: Sep. 1, 2005

(30) Foreign Application Priority Data
Oct. 7, 2004 (JP) 2004-294879

(51) Int. Cl. H01P 1/32

(52) U.S. Cl. 333/1.1; 333/24.2

(57) ABSTRACT

A lumped element non-reciprocal circuit device is downsized without an increase in an insertion loss. A lumped element non-reciprocal circuit device comprises a plurality of center electrodes; a microwave magnetic material; a permanent magnet; and a metal case that serves as a magnetic yoke, wherein the center electrode is disposed on a main surface of the microwave magnetic material, the microwave magnetic material has a side surface perpendicular to the main surface, and a shortest distance between the side surface of the microwave magnetic material and the metal case is set to be equal to or larger than a thickness of the microwave magnetic material and equal to or smaller than 2.3 times of the thickness of the microwave magnetic material.

### FIELD OF THE INVENTION

The present invention relates to a lumped element non-reciprocal circuit device used in a high frequency radio communication device such as a cellular phone.

### BACKGROUND OF THE INVENTION

In a market of a portable radio communication device represented by a cellular phone, the small size and the low power consumption have been strongly demanded, and the same performances have been inevitably demanded for parts used in a radio communication device. The same is applied to a lumped element non-reciprocal circuit device used in a high frequency circuit such as a radio communication device. The lumped element non-reciprocal circuit device does not consume the power, but a signal transmission loss leads to the deteriorated power efficiency. As a result, the low loss has been demanded.

FIG. 2 is an exploded diagram showing the structure of a lumped element non-reciprocal circuit device that is presently used as an isolator. As shown in the drawing, plural center electrodes that cross each other are disposed below a permanent magnet 9 so that static magnetic field is sufficiently applied to a microwave magnetic material 5. In addition, the entire circuit element is covered with metal cases 1 and 10 that serve as magnetic yokes in order to form a closed magnetic path. The structure shown in the figure is the lumped element non-reciprocal circuit device using two center conductors. Similarly, a lumped element non-reciprocal circuit device using three center conductors has the same magnetic circuit structure.

For example, Japanese Patent Laid-Open No. 2004-80111 and Japanese Patent Laid-Open No. H10(1998)-270917 disclose a lumped element non-reciprocal circuit device.

As the microwave magnetic material is reduced in size for the purpose of downsizing the lumped element non-reciprocal circuit device, the insertion loss is more increased. It is considered that this is caused by lowering an inductance of center conductors in order to downsize the microwave magnetic material, and increasing the loss attributable to a resistant component of the center electrode because a resonance current increases.

However, when only the metal case is reduced in size for the purpose of downsizing the lumped element non-reciprocal circuit device, the microwave magnetic material and the metal cases approach each other. As a result, a magnetic field developed by the permanent magnet within the microwave magnetic material is high in the vicinity of the center of the microwave magnetic material and low in the periphery of microwave magnetic material. This is because the magnetic flux developed by the permanent magnet is absorbed by the metal cases high in magnetic permeability, and the applied magnetic field becomes low at an end portion of the microwave magnetic material which is close to the metal cases. The nonuniformity of the magnetic field within the microwave magnetic material is considered to deteriorate the high frequency characteristic of the lumped element non-reciprocal circuit device, and is not preferable. There is no document including Japanese Patent Laid-Open No. 2004-80111 and Japanese Patent Laid-Open No. H10(1998)-270917, which discloses solving means paying attention to the above problem with the conventional circuit element.

The present invention has been made to solve the above problem, and therefore an object of the present invention is to provide a structure in which the uniformity of a magnetic field within a microwave magnetic material is obtained even in a downsized lumped element non-reciprocal circuit device.

### SUMMARY OF THE INVENTION

To achieve the above object, according to the present invention, there is provided a lumped element non-reciprocal circuit device comprising: a plurality of center electrodes; a microwave magnetic material; a permanent magnet; and a metal case that serves as a magnetic yoke, wherein the center electrode is disposed on a main surface of the microwave magnetic material, the microwave magnetic material has a side surface perpendicular to the main surface, and a shortest distance between the side surface of the microwave magnetic material and the metal case is set to be equal to or larger than a thickness of the microwave magnetic material and equal to or smaller than 2.3 times of the thickness of the microwave magnetic material.

In the lumped element non-reciprocal circuit device according to the present invention, it is preferable that at least a part of the side surface of the microwave magnetic material is made substantially in parallel with a surface of the metal case which is nearest to the microwave magnetic material.

The lumped element non-reciprocal circuit device according to the present invention comprises: a plurality of center electrodes; a microwave magnetic material; a permanent magnet; and a metal case that serves as a magnetic yoke, wherein the center electrode is disposed on a main surface of the microwave magnetic material, the microwave magnetic material has a side surface perpendicular to the main surface, and a shortest distance between the side surface of the microwave magnetic material and the metal case is set to be equal to or larger than a thickness of the microwave magnetic material and equal to or smaller than 2.3 times of the thickness of the microwave magnetic material. As a result, a magnetic field augmentation effect which is caused by reducing a diamagnetic field at the end portion of the microwave magnetic material and a magnetic field attenuation effect which is caused by absorbing a magnetic flux while the metal case approaches the microwave magnetic material offset each other. This makes it possible to obtain a uniform static magnetic field distribution within the microwave magnetic material.

Also, in the lumped element non-reciprocal circuit device according to the present invention, at least a part of the side surface of the microwave magnetic material is made substantially in parallel with a surface of the metal case which is nearest to the microwave magnetic material to develop the offset effect over a wide range. This makes it possible to obtain the more uniform magnetic field distribution.

### BRIEF DESCRIPTION OF THE DRAWINGS

FIG. 1 is a schematic cross-sectional view showing a lumped element non-reciprocal circuit device according to a first embodiment of the present invention;

FIG. 2 is an exploded perspective view showing the lumped element non-reciprocal circuit device according to the first embodiment of the present invention;

FIG. 3 is a graph showing a static magnetic field intensity distribution within a microwave magnetic material for explaining the present invention;

FIG. 4 is a graph showing the high frequency characteristics of an insertion loss according to the lumped element non-reciprocal circuit device (solid lines) of the present invention and a comparative example (dotted lines); and

FIG. 5 is a graph showing the high frequency characteristics of a reflection loss according to the lumped element non-reciprocal circuit device (solid lines) of the present invention and a comparative example (dotted lines).

### DETAILED DESCRIPTION OF THE PREFERRED EMBODIMENTS

Now, a description will be given in more detail of preferred embodiments of the present invention with reference to the accompanying drawings.

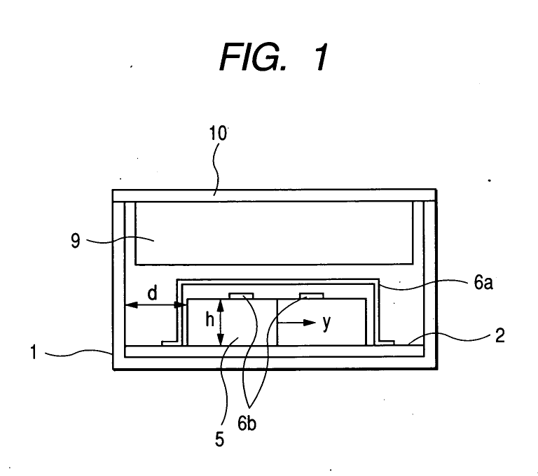

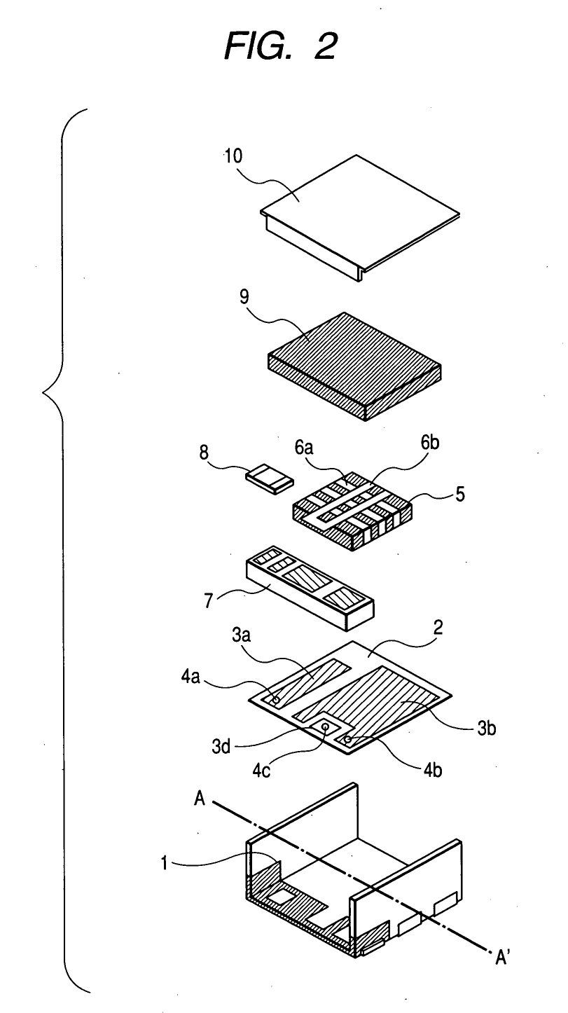

FIG. 2 is an exploded perspective view showing the lumped element non-reciprocal circuit device used in the present invention, and FIG. 1 is a schematically vertical cross-sectional view showing a lumped element non-reciprocal circuit device according to a first embodiment, taken along a plane A-A′ of FIG. 2, for explaining the present invention.

In FIG. 1, reference numeral 1 denotes a metal case which is mainly made of a ferromagnetic metal such as iron and normally subjected to conductor plating such as silver for reducing the loss caused by a high frequency eddy current because the metal case 1 also serves as a yoke for forming a closed magnetic path. Reference numeral 5 denotes a microwave magnetic material, and reference numeral 9 is a permanent magnet for applying a static magnetic field to the microwave magnetic material 5. Reference 6a and 6b are center electrodes which are made of nonmagnetic material.

In this embodiment, a rectangular solid that is 0.09 T in saturated magnetization, 0.3 mm in thickness (t), and 1.4 mm×1.4 mm in bottom surface is used as the microwave magnetic material 5.

The permanent magnet 9 is formed of a rectangular solid that is 0.41 T in residual magnetic flux density and 0.6 mm in thickness. The configuration of the bottom surface is rectangular, and the side length is adjusted to fit the metal case.

When the most of advantages of the present invention is going to be used, it is desirable that a portion in which a distance between the microwave magnetic material 5 and the metal case 1 is constant is more. In order to produce this configuration, a portion of the side surface of the microwave magnetic material 2 which is closest to the metal case 1 may be made substantially in parallel with a portion of the metal case 1 which is closest to the microwave magnetic material 2.

In order to realize the above configuration, the microwave magnetic material 5 is rectangular, and the side surface of the microwave magnetic material 5 is in parallel with the side surface of the metal case 1 in this embodiment.

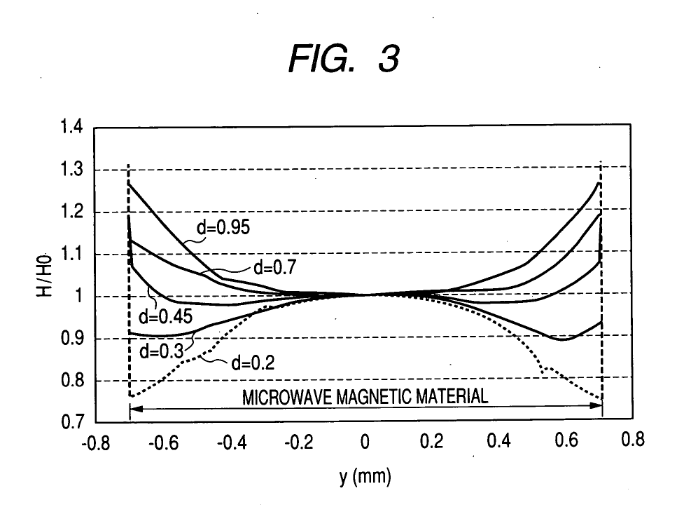

FIG. 3 shows the results of obtaining the static magnetic field within a microwave magnetic material through simulation in a situation where a distance between the microwave magnetic material 5 and the metal case 1 is d, and d is changed from 0.2 mm to 0.95 mm. The axis of ordinate (H/H0) represents a magnetic field intensity ratio of a magnetic field intensity H0 and the magnetic field intensities H at the respective positions in the case where the magnetic field intensity H0 in the center of the microwave magnetic material is set to 1. The axis of abscissa (y) represents a horizontal position that is directed from the center toward the metal case in the case where the center of the microwave magnetic material is set to 0. The microwave magnetic material of the portion that is high in static magnetic field becomes weak in the contribution to non-reciprocality because the permeability approaches 1. Also, in a portion of the microwave magnetic material which is low in the magnetic field, the resonance frequency is deteriorated, and the energy absorption becomes large, to thereby cause an increase in the insertion loss. It is desirable that the fluctuation of the magnetic field intensity ratio falls within ±10% at most of the portion of the microwave magnetic material.

As is apparent from FIG. 3, the static magnetic field becomes rapidly large at the end portion of the microwave magnetic material 5 at the time of d=0.95 mm. This is because the total magnetic field of the external magnetic field and the diamagnetic field becomes high because the diamagnetic field caused by the configuration of the microwave magnetic material becomes low.

Also, it is understood that the static magnetic field is reduced toward the end portion of the microwave magnetic material at the time of d=0.2 mm. This is because the static magnetic field becomes low since the magnetic flux is absorbed by the metal case that approaches the end portion of the magnetic material.

At the time of d=0.3 mm to 0.7 mm, both of the above effects offset each other, and it can be recognized that the magnetic field intensity ratios are uniformly distributed within a range of 0.9 to 1.1 at most points within the microwave magnetic material. Accordingly, a distance between the microwave magnetic material 2 and the metal case 1 is made to fall within the above range, thereby making it possible to downsize the lumped element non-reciprocal circuit device without deterioration of the characteristic of the lumped element non-reciprocal circuit device.

The distance d for producing the above effects depends on the thickness t of the microwave magnetic material. However, since the microwave magnetic material is spatially linear in the magnetic circuit, the distance d may be regulated at a ratio to the thickness t=0.3 mm of the microwave magnetic material when the result is generalized. Accordingly, the distance d is desirably in a range of 1 to 2.3 times of the thickness t of the microwave magnetic material.

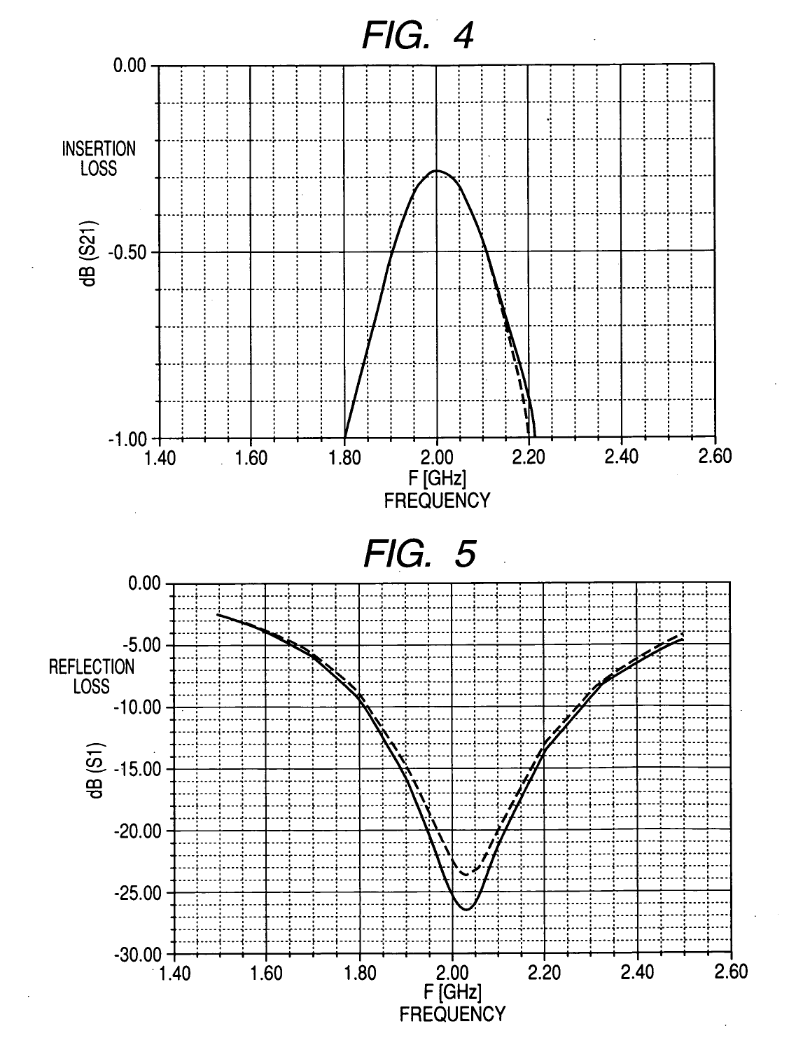

Subsequently, the above simulation result is recognized as the high frequency characteristic. FIGS. 4 and 5 show the high frequency characteristics of the reflection loss and the insertion loss of the lumped element non-reciprocal circuit device in the cases of d=0.45 mm (ratio to the thickness is 1.5) in the structure of the present invention and d=0.9 mm (ratio to the thickness is 3) in a comparative example. In both of the drawings, the solid lines represent the characteristics in the present invention whereas the dotted lines represent the characteristics in the comparative example.

In both of the lumped element non-reciprocal circuit device, a garnet material that is 0.09 T in saturated magnetization and 1.4 mm×1.4 mm×0.3 mm is used as the microwave magnetic material. The matching capacities are adjusted so that the center frequency becomes 2 GHz, respectively. An iron plate that is 0.15 mm in thickness and subjected to silver plating that is 10 μm in thickness is used as the metal case that also serves as the magnetic case.

In FIG. 4, it is recognized that both of the insertion losses in the above two cases are about 0.3 dB, that is, substantially identical with each other when the center frequency is 2 GHz. The loss in the vicinity of 2.2 GHz in the present invention is slightly smaller than that in the comparative example.

In FIG. 5, it can be recognized that the reflection loss is widened in range by application of the present invention. It is considered that this is because the same effect as that obtained at the time of using a larger-sized microwave magnetic material is effectively obtained by making the magnetic field uniform. Thus, it can be recognized that the present invention is effective.

The lumped element non-reciprocal circuit device according to the present invention can be used for a high frequency radio communication device such as a cellular phone or a cellular terminal.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A lumped element non-reciprocal circuit device comprising:
a plurality of center electrodes;
a microwave magnetic material;
a permanent magnet; and
a metal case that serves as a magnetic yoke,
wherein the center electrode is disposed on a main surface of the microwave magnetic material, and a shortest distance between a side surface of the microwave magnetic material and the metal case is set to be equal to or larger than a thickness of the microwave magnetic material and equal to or smaller than 2.3 times of the thickness of the microwave magnetic material.

2. The lumped element non-reciprocal circuit device according to claim 1, wherein at least a part of the side surface of the microwave magnetic material is made substantially in parallel with a surface of the metal case which is nearest to the microwave magnetic material.
